(19) United States
(12) Patent Application Publication
(10) Pub. No.: US 2023/0071101 A1
(43) Pub. Date: Mar. 9, 2023

(54) APPARATUS AND METHOD FOR SENSING A SCENE

(71) Applicant: Infineon Technologies AG, Neubiberg (DE)

(72) Inventors: Armin Josef SCHOENLIEB, Seiersberg-Pirka (AT); Caterina NAHLER, Thondorf (AT); Hannes PLANK, Graz (AT)

(21) Appl. No.: 17/822,314

(22) Filed: Aug. 25, 2022

(30) Foreign Application Priority Data
Sep. 8, 2021 (DE) 102021123254.6

(51) Int. Cl. G06V 10/60; G06V 10/141; G01S 17/894

(52) U.S. Cl. CPC G06V 10/60; G06V 10/141; G01S 17/894

(57) ABSTRACT

An apparatus for sensing a scene is provided. The apparatus includes an illumination element configured to illuminate the scene with modulated light. Additionally, the apparatus includes an optical sensor configured to receive reflected light from the scene. The optical sensor includes at least one photo-sensitive sensor pixel configured to store charge carriers generated in the photo-sensitive sensor pixel by the reflected light in at least one charge storage of the photo-sensitive sensor pixel during a measurement. The at least one photo-sensitive sensor pixel is further configured to selectively prevent the charge carriers from reaching the at least one charge storage during the measurement to strictly monotonically increase a sensitivity of the at least one photo-sensitive sensor pixel over distance for reflected light originating within a measurement range of the optical sensor.

### CROSS REFERENCE TO RELATED APPLICATION

This application claims priority to German Patent Application No. 102021123254.6 filed on Sep. 8, 2021, the content of which is incorporated by reference herein in its entirety.

### TECHNICAL FIELD

The present disclosure relates to optical sensing. In particular, examples of the present disclosure relate to an apparatus and a method for sensing a scene.

### BACKGROUND

When vision systems use cameras that feature an active illumination source (e.g., Time-of-Flight, ToF, cameras), close objects reflect more light back to the imager, while distant objects of the same reflectivity receive less light and reflect less light back. Accordingly, close objects may cause pixels of the imager to saturate while objects of the same material appear differently at different distances.

Further, the amount of electrons accumulated in the pixel depends on the reflectance of the object. Determining the reflectance of an object may improve object detection and recognition. The reflectance measurement may be distorted by pixel saturation caused by close objects.

Furthermore, when using an active illumination system, a vision system wants as little light from other light sources (e.g., sunlight) as possible.

Hence, there may be a demand for improved optical sensing.

### SUMMARY

The demand may be satisfied by the subject-matter of the appended claims.

An example relates to an apparatus for sensing a scene. The apparatus includes an illumination element configured to illuminate the scene with modulated light. Additionally, the apparatus includes an optical sensor configured to receive reflected light from the scene. The optical sensor includes at least one photo-sensitive sensor pixel configured to store charge carriers generated in the photo-sensitive sensor pixel by the reflected light in at least one charge storage of the photo-sensitive sensor pixel during a measurement. The at least one photo-sensitive sensor pixel is further configured to selectively prevent the charge carriers from reaching the at least one charge storage during the measurement to strictly monotonically increase a sensitivity of the at least one photo-sensitive sensor pixel over distance for reflected light originating within a measurement range of the optical sensor.

Another example relates to a method for sensing a scene. The method includes illuminating the scene with modulated light using an illumination element. Additionally, the method includes receiving reflected light from the scene at an optical sensor. The optical sensor includes at least one photo-sensitive sensor pixel. The method further includes controlling the at least one photo-sensitive sensor pixel to store charge carriers generated in the photo-sensitive sensor pixel by the reflected light in at least one charge storage of the photo-sensitive sensor pixel during a measurement. In addition, the method includes controlling the at least one photo-sensitive sensor pixel to selectively prevent the charge carriers from reaching the at least one charge storage during the measurement to strictly monotonically increase a sensitivity of the at least one photo-sensitive sensor pixel over distance for reflected light originating within a measurement range of the optical sensor.

### BRIEF DESCRIPTION OF THE DRAWINGS

Some examples of apparatuses and/or methods will be described in the following by way of example only, and with reference to the accompanying figures, in which

FIG. 1 illustrates an example of an apparatus for sensing a scene;

FIG. 2 an example of a photo-sensitive sensor element or pixel;

FIG. 3 illustrates example courses of received light intensity at and sensitivity of a photo-sensitive sensor element or pixel;

FIG. 4 illustrates another example of a photo-sensitive sensor element or pixel;

FIG. 5 illustrates an example correlation signal together with example light and state signals for a photo-sensitive sensor element or pixel; and

FIG. 6 illustrates a flowchart of an example of a method for sensing a scene.

### DETAILED DESCRIPTION

Some examples are now described in more detail with reference to the enclosed figures. However, other possible examples are not limited to the features of these implementations described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

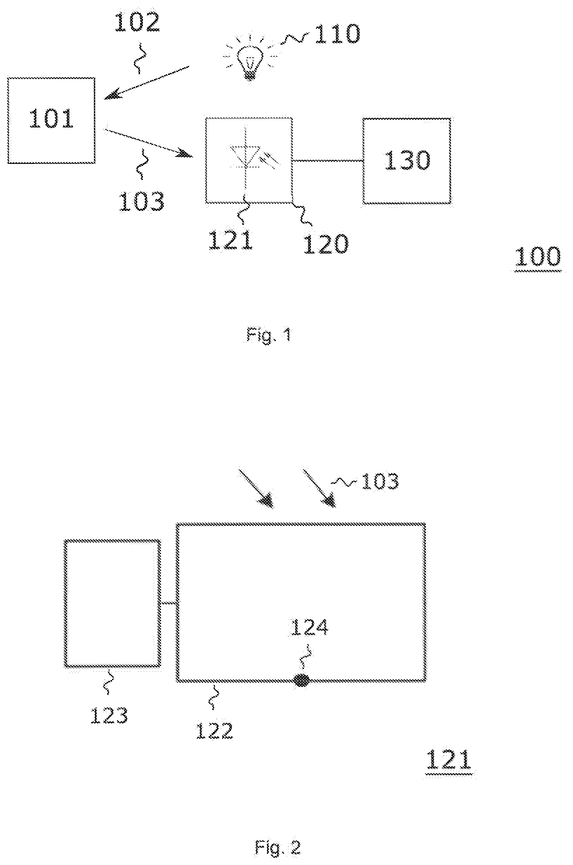

FIG. 1 illustrates an example of an apparatus 100 for sensing a scene.

The apparatus includes an illumination element (circuitry, device) 110 configured to illuminate the scene with modulated light 102 (e.g., modulated light pulses). The illumination element 110 may comprise any number of light sources. The illumination element 110 may, e.g., comprise one or more Light-Emitting Diode (LED) and/or one or more laser diode (e.g., one or more Vertical-Cavity Surface-Emitting Laser, VCSEL) which is fired based on one or more illumination signal.

An object 101 is located in the scene and reflects the emitted modulated light 102. The object 101 may be any kind of physical object. The reflected light 203 travels at least partially back to the apparatus 100.

The apparatus 100 includes an optical sensor 120 configured to receive (capture) the reflected light 103 from the scene. The optical sensor 120 may comprise various components such as e.g., optics (e.g., one or more lens) and electronic circuitry. In particular, the electronic circuitry comprises at least one photo-sensitive sensor element or pixel (e.g., comprising a Photonic Mixer Device, PMD, or a Charge-Coupled Device, CCD). For example, the optical sensor 120 may comprise a plurality of photo-sensitive sensor elements or pixels (e.g., N≥2 photo-sensitive sensor elements or pixels). The at least one photo-sensitive sensor element or pixel may be driven based on one or more drive (reference) signal.

In general, the optical sensor 120 may be any type of sensor that is able to measure a physical quantity of the light (such as the reflected light 203) and then translate it into a form that is readable by further electronic circuitry. In particular, the optical sensor 120 may be any type of sensor that is able convert light or a change in light into an electronic signal. For example, the optical sensor 120 may be a frame based image sensor comprising photo-sensitive sensor elements or pixels that operate uniformly and synchronously to detect light framewise. Alternatively, the optical sensor 120 may, e.g., be a ToF sensor measuring a ToF of the emitted modulated light 102 using the reflected light 103 received at the optical sensor 120. Further alternatively, the optical sensor 120 may, e.g., be an event based vision sensor such as a dynamic vision sensor (also known as event camera, neuromorphic camera or silicon retina) that responds to local changes in brightness. An event based vision sensor does not capture an images/frames using a shutter like a conventional image sensor does. Instead, the photo-sensitive sensor element or pixels of an event based vision sensor operate independently and asynchronously, detecting changes in brightness as they occur, and staying silent otherwise. An event based vision sensor may provide high temporal resolution, high dynamic range, under/overexposure and motion blur compared to frame based image sensors.

An example photo-sensitive sensor element or pixel 121 is illustrated in FIG. 2. In case the optical sensor 120 comprises a plurality of photo-sensitive sensor elements or pixels, one or more of the plurality of photo-sensitive sensor elements or pixels may be formed and operated like the photo-sensitive sensor element or pixel 121 described in the following.

The photo-sensitive sensor element or pixel 121 comprises a semiconductor material/substrate 122 (e.g., silicon). The reflected light 103 penetrates the semiconductor material 122 and causes generation of charge carriers (e.g., electrons or holes) in the semiconductor material 122.

The photo-sensitive sensor element or pixel 121 further comprises at least one charge storage such as the charge storage 123 illustrated in FIG. 2. Although exactly one charge storage is illustrated in FIG. 2 for the photo-sensitive sensor element or pixel 121, it is to be noted that the present disclosure is not limited thereto. In general any number M≥1 of charge storages may be used per photo-sensitive sensor element or pixel. For example, the at least one charge storage may be a (respective) capacitor or potential well formed in the semiconductor material 122 of the photo-sensitive sensor element or pixel 121. It is to be noted that the charge storage 123 is illustrated as separate element in FIG. 1 for illustrative purposes only. The at least one charge storage is part of the photo-sensitive sensor element or pixel 121. The at least one charge storages allows to (e.g., selectively) store the generated charge carriers.

During a measurement (e.g., a single exposure of the optical sensor 120), the at least one photo-sensitive sensor element or pixel 121 is configured (e.g., controlled by the optical sensor 120) to (e.g., selectively) store the charge carriers, which are generated in the semiconductor material 122 of the photo-sensitive sensor pixel 121 during the measurement by the reflected light 103, in the at least one charge storage 123. The output (value, data) of the at least one photo-sensitive sensor element or pixel 121 for the measurement is determined based on the charge level(s) of the at least one charge storage 123.

Additionally, the photo-sensitive sensor element or pixel 121 comprises a drain terminal 124. The drain terminal 224 is a terminal that allows to selectively drain the generated charge carriers from the photo-sensitive sensor element or pixel 121.

During the measurement, the at least one photo-sensitive sensor element or pixel 121 is further configured (e.g., controlled by the optical sensor 120) to selectively drain the generated charge carriers in order to strictly monotonically increase a sensitivity of the at least one photo-sensitive sensor pixel 121 over distance for reflected light 103 originating within a (target) measurement range of the optical sensor 120. In other words, the at least one photo-sensitive sensor pixel 121 is further configured to selectively prevent the charge carriers from reaching the at least one charge storage 123 during the measurement to strictly monotonically increase a sensitivity of the at least one photo-sensitive sensor pixel 121 over distance for reflected light 103 originating within the (target) measurement range of the optical sensor 120.

The (target) measurement range of the optical sensor 120 is a distance range in which a respective quantity of one or more object such as the object 101 is to be measured by the optical sensor 120. The sensitivity of the at least one photo-sensitive sensor pixel 121 denotes the degree to which the at least one photo-sensitive sensor pixel 121 responds to the reflected light 103 originating from a certain distance. The higher the sensitivity of the at least one photo-sensitive sensor pixel 121 for reflected light 103 originating from a certain distance, the higher is the output (value, data) of the at least one photo-sensitive sensor pixel 121 for reflected light 203 originating from this distance.

Only the charge carriers stored in the at least one charge storage 123 during the measurement contribute to the output (value, data) of the at least one photo-sensitive sensor element or pixel 121. Accordingly, by selectively preventing some (part) of the generated charge carriers from reaching the at least one charge storage 123 during the measurement, the distance-dependent sensitivity of the optical sensor 120 may be adjusted (shaped).

In the example of FIG. 2, the photo-sensitive sensor element or pixel 121 comprises the drain terminal 124 for draining part of the generated charge carriers and, hence, preventing the latter from reaching the at least one charge storage 123. However, it is to be noted that the present disclosure is not limited thereto. In other examples, the drain terminal 124 may be omitted and the photo-sensitive sensor element or pixel 121 may be configured to electrically decouple (isolate) the at least one charge storages 123 from the semiconductor material 122 such that the generated charge carriers cannot reach the at least one charge storages 123. In general, any technique may be used for selectively preventing part of the charge carriers generated during the measurement from reaching the at least one charge storages 123.

For example, the at least one photo-sensitive sensor pixel 121 may be configured to selectively prevent the charge carriers from reaching the at least one charge storage 123 based on the at least one drive signal for the photo-sensitive sensor pixel 121. Similarly, the at least one photo-sensitive sensor pixel 121 may be configured to (e.g., selectively) store the charge carriers in the at least one charge storage 123 based on the at least one drive signal for the photo-sensitive sensor pixel 121. The at least one drive signal may, e.g., be received by the at least one photo-sensitive sensor pixel 121 from another circuitry of the optical sensor 120 or from circuitry external to the optical sensor 120.

The at least one photo-sensitive sensor pixel 121, hence, effectively comprises a “shutter” such as the drain terminal 124 that enables to prevent generated charge carriers from reaching the at least one charge storage 123. As described above, the “shutter functionality” of the at least one photo-sensitive sensor pixel 121 may be controlled based on the one or more drive signal. Accordingly, it may be controlled whether or nor the generated charge carriers are accumulated or not during the measurement.

For example, the at least one photo-sensitive sensor element or pixel 121 may provide an integration state during which the charge carriers, which are generated during the measurement by the reflected light 103, are being selectively stored in the at least one charge storage 123. Further, the at least one photo-sensitive sensor element or pixel 121 may provide a drain (non-integrating) state during which the charge carriers, which are generated during the ToF measurement by the reflected light 103, are prevented from reaching the at least one charge storage 123 (e.g., the charge carriers, which are generated during the ToF measurement by the reflected light 103, may be drained via the drain terminal 124 or the at least one charge storage 123 may be electrically decoupled/isolated from the semiconductor material 122 during the drain/non-integrating state). During the measurement, the at least one photo-sensitive sensor element or pixel 121 may operate according to a state pattern. The state pattern may, e.g., alternatingly comprise the integration state and the drain state such that each two subsequent integration states are separated by a drain state. By alternatingly draining and storing the charge carriers over time and by selecting (setting, adjusting) appropriate durations for the integration state(s) and the drain state(s), the timing(s) and duration(s) of the drain state(s) during the measurement may be adjusted such that the sensitivity of the at least one photo-sensitive sensor pixel 121 increases strictly monotonically over distance within the measurement range of the ToF sensor 100. The state pattern may, e.g., be encoded to the one or more drive signal for the photo-sensitive sensor pixel 121.

Optionally, the photo-sensitive sensor element or pixel 121 may comprise one or more further elements such as control gates for controlling the flow of the generated charge carriers inside the photo-sensitive sensor element or pixel 121 (e.g., two or more modulation gates and/or one or more drain gates) and/or read-out terminal(s) for reading out the at least one charge storage.

Due to the increasing sensitivity of the at least one photo-sensitive sensor element or pixel 121 within the measurement range of the optical sensor 120, the measurement is less sensitive to reflected light 103 coming from the close proximity of the optical sensor 120. In other words, the sensitivity of the at least one photo-sensitive sensor element or pixel 121 is shaped (adjusted) such that more sensitivity is given to distances (regions) further away from the optical sensor 120. As a consequence, near distances (regions) get less sensitivity and far distances (regions) get higher sensitivity. Further, saturation of the at least one photo-sensitive sensor element or pixel 121 by reflected light 103 coming from the close proximity of the optical sensor 120 may be avoided. As a consequence distortion of the measurement due to pixel saturation may be avoided.

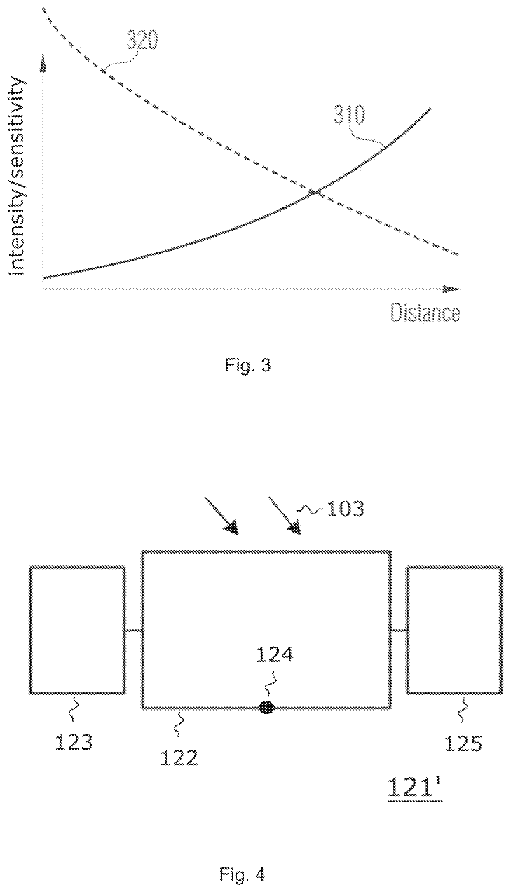

FIG. 3 illustrates an example course 310 of the photo-sensitive sensor element or pixel 121's sensitivity. Further, FIG. 3 illustrates an example course 320 of the light strength (intensity) of the reflected light 103 received at the optical sensor 120. The abscissa of FIG. 3 denotes the distance between the optical sensor 120 and the object 101. The ordinate denotes the respective value of the photo-sensitive sensor element or pixel 121's sensitivity and the light strength of the reflected light 103. In the example of FIG. 3, it is assumed that the distances of the whole abscissa are within the measurement range of the optical sensor 120.

As can be seen from the example course 310, the photo-sensitive sensor element or pixel 121's sensitivity is increasing strictly monotonically over distance (e.g., the photo-sensitive sensor element or pixel 121's sensitivity strictly monotonically increases for larger distances between the optical sensor 120 and the object 101). In the example of FIG. 3, the photo-sensitive sensor element or pixel 121's sensitivity increases substantially quadratically over distance within the measurement range. In other words, the photo-sensitive sensor element or pixel 121's sensitivity S may, e.g., be adjusted as follows:

S(d)∝d² (1)

with d denoting distance between the optical sensor 120 and the object 101 reflecting the emitted modulated light 102 back to the optical sensor 120.

In order to increase its sensitivity over distance, the at least one photo-sensitive sensor element or pixel 121 may be controlled to decrease the ratio of drained charged carriers with increasing distance of the optical sensor 120 to the object 101 in the scene (causing the reflected light). In other words, the at least one photo-sensitive sensor element or pixel 121 may be controlled to decrease the ratio of charged carriers prevented from reaching the at least one charge storage 123. Accordingly, the at least one photo-sensitive sensor element or pixel 121 may be configured to increase the ratio of charge carriers stored in the at least one charge storage 121 with increasing distance of the optical sensor 120 to the object 101 in the scene (causing the reflected light).

As can be seen from course 320, the light strength of the reflected light 203 is decreasing over the distance between the optical sensor 120 to the object 101. For example, it may be assumed (e.g., for point-like light-sources) that the light strength decreases according to the inverse square law. That is, the distance-dependent light strength of the reflected light 103 received at the optical sensor 120 may be assumed as follows:

$$I ( d ) ∝ \frac{1}{{d}^{2}} \qquad ( 2 )$$

with I denoting the light strength of the reflected light 103 received at the optical sensor 120.

As the sensitivity of the optical sensor 120 for light from the close proximity of the optical sensor 120 is reduced due to the drainage, saturation of the at least one photo-sensitive sensor element or pixel 121 due to strong reflections from the close proximity of the optical sensor 120 may be avoided. Additionally, glare effects or stray light effects caused by reflections of the emitted modulated light 102 by an object in the close proximity of the optical sensor 120 may be omitted or at least reduced.

The output of the at least one photo-sensitive sensor element or pixel 121 for the measurement scales with the light strength of the reflected light 103 received from the object 101. For example, an output value output by the at least one photo-sensitive sensor element or pixel 121 for the measurement may be determined by the product of the light strength of the reflections received from the object 201 during this measurement and the photo-sensitive sensor element or pixel 121's sensitivity at the distance of the object 101 causing the reflected light 103.

Accordingly, adjusting the photo-sensitive sensor element or pixel 121's sensitivity such that the sensitivity for the measurement is strictly monotonically increasing over distance within the measurement range of the optical sensor 120 may allow to compensate for the decreasing light strength of the reflected light 203 received at the optical sensor 120. The decreasing light strength of the reflected light 203 received at the optical sensor 120 may in particular be compensated if the photo-sensitive sensor element or pixel 121's sensitivity increases substantially quadratically over distance within the measurement range. As a consequence, if the object 101 is located within the measurement range of the optical sensor 120, an output value of the photo-sensitive sensor element or pixel 121 or the optical sensor 120 for the measurement may be substantially independent of the distance between the optical sensor 120 and the object 101.

The output value of the at least one photo-sensitive sensor pixel 121 for the measurement is proportional to the reflectivity of the object 101 as the reflectivity of the object 101 determines how much light arrives at the optical sensor 120 and, hence, the at least one photo-sensitive sensor pixel 121 during the measurement. The reflectivity of an object determines the ratio between the amount of emitted modulated light 102 arriving at a surface of the object 101 and the amount of light that is reflected back to the optical sensor 120 (e.g., the amount of the reflected light 103). Accordingly, in case the object 101 is located within the measurement range of the optical sensor 120, the output value of the at least one photo-sensitive sensor pixel 121 varies with the reflectivity of the object 101—independent of the distance between the optical sensor 120 and the object 101. Therefore, the output value of the at least one photo-sensitive sensor pixel 121 may allow to characterize the reflectivity of the object 101 when shaping the at least one photo-sensitive sensor pixel 121's sensitivity as described above.

For determining the reflectivity of the object 101, the apparatus 100 as illustrated in FIG. 1 may optionally further comprise processing circuitry 130 coupled to the optical sensor 120. For example, the processing circuitry 130 may be a single dedicated processor, a single shared processor, or a plurality of individual processors, some of which or all of which may be shared, a digital signal processor (DSP) hardware, an application specific integrated circuit (ASIC) or a field programmable gate array (FPGA). The processing circuitry 130 may optionally be coupled to, e.g., read only memory (ROM) for storing software, random access memory (RAM) and/or non-volatile memory. The processing circuitry 130 is configured to determine a reflectivity value indicating a reflectivity of the object 101 in the scene based on the output value of the at least one photo-sensitive sensor pixel 121 for the measurement.

For example, the processing circuitry 130 may determine the reflectivity value by applying at least one correction to the output value of the at least one photo-sensitive sensor pixel 121 for the measurement. The output value of the at least one photo-sensitive sensor pixel 121 for the measurement may, e.g., be scaled and/or offset-corrected to obtain the reflectivity value. Accordingly, systematic errors (e.g., noise) may be corrected.

For example, the processing circuitry 130 may further output data indicative of the reflectivity value (e.g., a two-dimensional image).

According to examples, the processing circuitry 130 may further be coupled to the illumination element 110 and be configured to control the illumination element 110 as described above.

The apparatus 100 may comprise further hardware—conventional and/or custom.

The following description focuses on an example of the present disclosure in which the optical sensor 120 is a ToF sensor. Accordingly, the measurement is ToF measurement.

FIG. 4 illustrates an example photo-sensitive sensor element or pixel 121′ for the ToF sensor 120. The ToF sensor 120 may comprise at least one photo-sensitive sensor element or pixel that is implemented like the photo-sensitive sensor element or pixel 121′. For example, the ToF sensor 120 may comprise a plurality of photo-sensitive sensor elements or pixels that are implemented like the photo-sensitive sensor element or pixel 121′.

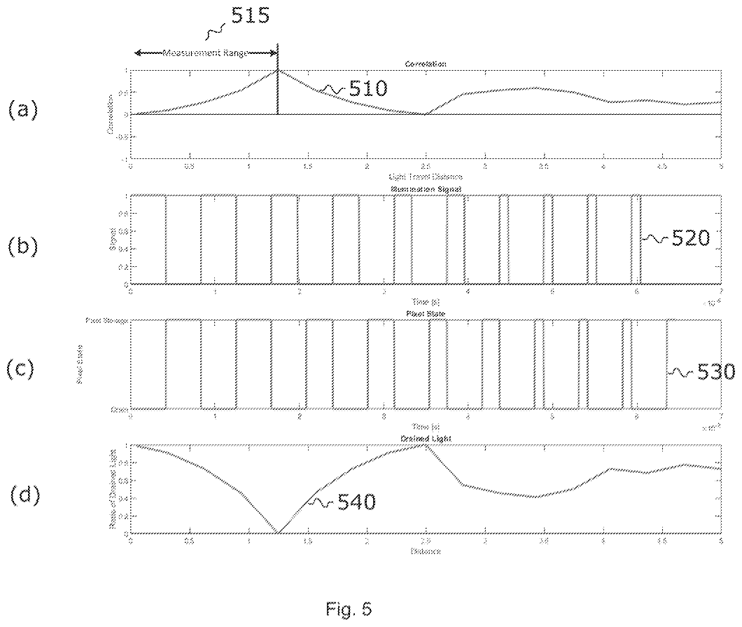

The photo-sensitive sensor element or pixel 121′ is substantially identical to the photo-sensitive sensor element or pixel 121 described above with respect to FIG. 3. Compared to the photo-sensitive sensor element or pixel 121, the photo-sensitive sensor element or pixel 121′ comprises an additional charge storage 125. The additional charge storage 125 may be implemented as described above for the charge storage 123. It is to be noted that the charge storages 123 and 125 are illustrated as separate elements in FIG. 5 for illustrative purposes only. The two charge storages are part of the photo-sensitive sensor element or pixel 121′. The two charge storages 123 and 125 allow to selectively store the generated charge carriers. Although exactly two charge storages are illustrated in FIG. 5 for photo-sensitive sensor element or pixel 121′, it is to be noted that the present disclosure is not limited thereto. In general any number K≥2 of charge storages may be used per photo-sensitive sensor element or pixel of the ToF sensor 120.

Similarly to what is described above for the photo-sensitive sensor element or pixel 121 with the single charge storage 123, the at least one photo-sensitive sensor pixel 121′ is configured to selectively store the generated charge carriers in the at least two charge storages 123 and 125 of the at least one photo-sensitive sensor element or pixel 121′ during the ToF measurement. The output (value, data) of the at least one photo-sensitive sensor element or pixel 121′ for the ToF measurement is determined based on the charge levels of the at least two charge storages 123 and 125. For example, the output value of the at least one photo-sensitive sensor element or pixel 121′ for the ToF measurement may be based on the difference between the charge levels of the two charge storages of the at least two charge storages 123 and 125. In other words, the output value of the at least one photo-sensitive sensor element or pixel 121′ for the ToF measurement may be based on a charge difference between stored charges in the at least two charge storages 123 and 125. Background light arriving at the ToF sensor 120 causes generation of unwanted charge carriers. The charge carriers caused by the background light are stored in all of the at least two charge storages 123 and 125. Accordingly, if the output value of the at least one photo-sensitive sensor element or pixel 121′ for the ToF measurement is based on a charge difference between stored charges in the at least two charge storages 123 and 125, the effect of the background light on the ToF measurement may be cancelled or at least mitigated. For example, the at least one photo-sensitive sensor pixel 121′ may be configured to store the generated charge carriers for the same amount of time in each of the at least two charge storages 123 and 125 during the ToF measurement. Accordingly, the amount of charge carriers caused by the background light is substantially the same in all of the at least two charge storages 123 and 125 such that they substantially cancel out. This may allow to further improve the reflectivity measurement with the ToF sensor 120.

Analogously to what is described above, the at least one photo-sensitive sensor pixel 121′ is configured to selectively prevent the generated charge carriers from reaching the at least two charge storages 123 and 125 during the ToF measurement. For example, the at least one photo-sensitive sensor pixel 121′ may be configured to selectively prevent the charge carriers from reaching the at least one charge storage 123 and 125 during the ToF measurement by selectively draining the generated charge carriers via the drain terminal 124. However, it is to be noted that the present disclosure is not limited thereto. In other examples, the drain terminal 124 may be omitted and the photo-sensitive sensor element or pixel 121′ may, e.g., be configured to electrically decouple (isolate) the at least two charge storages 123 and 125 from the semiconductor material 122 such that the generated charge carriers cannot reach the at least two charge storages 123 and 125. In general, any technique may be used for selectively preventing part of the charge carriers generated during the measurement from reaching the at least two charge storages 123 and 125.

Like the at least one photo-sensitive sensor pixel 121 described above, the at least one photo-sensitive sensor pixel 121′ may allow to selectively prevent some (part) of the generated charge carriers from reaching the at least two charge storages 123 and 125 during the ToF measurement. As only the charge carriers stored in the at least two charge storages 123 and 125 during the ToF measurement contribute to the output (value, data) of the at least one photo-sensitive sensor element or pixel 121 for the ToF measurement, the distance-dependent sensitivity of the ToF sensor 120 may be adjusted (shaped).

The sensitivity of a photo-sensitive sensor element or pixel for a ToF measurement is given by its (light-intensity-independent) correlation function for the ToF measurement. The (light-intensity-independent) correlation function of the at least one photo-sensitive sensor element or pixel 121′ for a ToF measurement gives the at least one photo-sensitive sensor pixel 121's distance-dependent correlation of the reflected light 103 with one or more drive signal used for driving the at least one photo-sensitive sensor element or pixel 121′ during the ToF measurement and without considering (e.g., ignoring, not taking into account) an intensity of the reflected light 103. In other words, the (light-intensity-independent) correlation function only describes the distance-dependency of the photo-sensitive sensor pixel's output (value, data) but not the dependency of the photo-sensitive sensor pixel's output (value, data) on the intensity of the reflected light 103. Analogously to what is described above for the sensitivity, the correlation function of the at least one photo-sensitive sensor pixel 121′ for the ToF measurement increases strictly monotonically over distance within the (target) measurement range of the ToF sensor 120. For example, the correlation function may increase substantially quadratically over distance within the measurement range.

FIG. 5 illustrates in subfigure (a) an example correlation function 510 of the at least one photo-sensitive sensor element or pixel 121′ for a ToF measurement. The abscissa of subfigure (a) denotes the distance between the ToF sensor 120 and the object 101. The ordinate denotes the value of the correlation function. In the example of FIG. 5, the (target) measurement range 515 of the ToF sensor 120 ranges from approx. 0 to 1.25. Similar to the sensitivity illustrated in FIG. 3, the correlation function 510 increases strictly monotonically over distance within the measurement range 515. In particular, the correlation function 510 increase substantially quadratically over distance within the measurement range 515. The correlation function 510 may be valid only within the measurement range 515.

Subfigure (b) of FIG. 5 illustrates an example sequence of modulated light pulses 520 that is emitted to scene by the light emitting element 120 for the ToF measurement. The abscissa of subfigure (b) denotes time. The ordinate denotes the amplitude of the illumination signal controlling the light emitting element 120 to emit the light pulses.

Subfigure (c) of FIG. 5 illustrates an example temporal course 530 of the state of the at least one photo-sensitive sensor element or pixel 121′ during the ToF measurement. The abscissa of subfigure (c) denotes time. The ordinate denotes the state of the at least one photo-sensitive sensor element or pixel 121′. As indicated in subfigure (c) of FIG. 5, two states are possible.

While the at least one photo-sensitive sensor element or pixel 121′ is in state “Pixel Storage”, the at least one photo-sensitive sensor element or pixel 121′ selectively stores the charge carriers, which are generated during the ToF measurement by the reflected light 103, in the at least two charge storage 123 and 125. For example, the at least one photo-sensitive sensor element or pixel 121′ may selectively store the generated charge carriers in the at least two charge storage 123 and 125 according to a modulation code that is encoded to the one or more drive signal used for driving the at least one photo-sensitive sensor element or pixel 121′ during the ToF measurement. In other words, the at least one photo-sensitive sensor element or pixel 121′ provides an integration state during which the charge carriers, which are generated during the ToF measurement by the reflected light 103, are being selectively stored in the at least two charge storages 123 and 125.

While the at least one photo-sensitive sensor element or pixel 121′ is in state “Drain”, the at least one photo-sensitive sensor element or pixel 121′ selectively drains the charge carriers, which are generated during the ToF measurement by the reflected light 103, via the drain terminal 124. No charge carriers are stored in the charge storages 123 and 125 while the at least one photo-sensitive sensor element or pixel 221 is in the state “Drain”. In other words, the at least one photo-sensitive sensor element or pixel 121′ provides a drain (non-integrating) state during which the charge carriers, which are generated during the ToF measurement by the reflected light 103, are prevented from reaching the at least one charge storage 123. The charge carriers, which are generated during the ToF measurement by the reflected light 103, may be not only be drained via the drain terminal 124. In other examples, the at least one charge storage 123 may be electrically decoupled (isolated) from the semiconductor material 122 during the drain (non-integrating) state.

The state of the at least one photo-sensitive sensor element or pixel 121′ is controlled by the one or more drive signal used for driving the at least one photo-sensitive sensor element or pixel 121′ during the ToF measurement. For example, during the ToF measurement, the at least one photo-sensitive sensor element or pixel 121′ may operate according to a state pattern encoded to the one or more drive signal. As illustrated in subfigure (c), the state pattern may, e.g., alternatingly comprise the integration state and the drain state such that each two subsequent integration states are separated by a drain state. By alternatingly draining and storing the charge carriers over time and by selecting (adjusting) appropriate durations for the integration state(s) and the drain state(s), the timing(s) and duration(s) of the drain state(s) during the ToF measurement may be adjusted such that the correlation function 510 of the at least one photo-sensitive sensor pixel 121′ for the ToF measurement increases strictly monotonically over distance within the measurement range 515 of the ToF sensor.

Subfigure (d) of FIG. 5 illustrates an example distance dependent ratio 540 of the generated charge carriers selectively drained via the drain terminal 124. The abscissa of subfigure (d) denotes the distance between the ToF sensor 120 and the object 101. The ordinate denotes the ratio of drained charged carriers. As can be seen from subfigure (d), the at least one photo-sensitive sensor element or pixel 121′ is controlled to decrease the ratio of drained charged carriers with increasing distance of the object 101 (causing the incident light 103) to the ToF sensor 120. In other words, the at least one photo-sensitive sensor element or pixel 121 is controlled to increase a ratio of the generated charge carriers selectively stored in the at least two charge storages 123 and 125 with increasing distance of the ToF sensor 120 to the object 101 causing the incident light 103. The decrease in the ratio of drained charged carriers over distance is achieved by appropriately setting the durations for the integration state(s) and the drain state(s) in the state pattern.

As can be seen from subfigure (d), only a portion of the charge carriers generated by reflected light 103 coming from the start of the measurement range 515 gets stored in the at least two charge storages 123 and 125. The stored charge carriers contribute to the correlation function 510 illustrated in subfigure (a). The rest of the charge carriers is removed (drained) from the at least one photo-sensitive sensor element or pixel 121′ via the drain terminal 124 and, hence, not stored in the at least two charge storages 123 and 125. This is achieved as the reflected light 103 causing these charge carriers arrives while the at least one photo-sensitive sensor element or pixel 121′ is in the state “Drain”. Charge carriers caused by reflected light 103 from the far end of the measurement range are substantially completely stored in the at least two charge storages 123 and 125 and, hence, contribute more to the correlation function 510 illustrated in subfigure (a). Accordingly, the amplitude of the correlation function 510 strictly monotonically increases over distance within the measurement range 515 of the ToF sensor 120.

There are various, substantially infinite ways on how to configure (shape) the one or more drive signal driving the at least one photo-sensitive sensor element or pixel 121′ of the ToF sensor 120 and the one or more illumination signal for driving the illumination element 110 in order to create correlation functions that behave like in the above described example of FIG. 5. Therefore, it is to be noted that the present disclosure is not limited to the specific configuration (shape) of the one or more drive signal and the one or more illumination signal. The signal structures illustrated in FIG. 5 are, hence, merely for illustration. For example, sequences illustrated in subfigure (c) of FIG. 5 may, e.g., be repeated multiple times or mixed. Alternatively, different signal patters may be used. Similarly, the length of the light pulses illustrated in subfigure (c) of FIG. 5 may be homogenous or feature a different pattern than shown in subfigure (c) of FIG. 5. In general, the one or more drive signal and the one or more illumination signal are chosen such that charge carriers caused by incident light from closer ranges are drained to a certain extent in order to cause the respective correlation function to increase strictly monotonically over distance. For example, the emitted light pulses 520 and the one or more drive signal (which may be understood as pixel state signal(s)) may be shaped such that the inverse of the light dilution function (see mathematical expression (2)) is approximated. The frequency of the one or more drive signal and the illumination signal may be adapted to the target measurement range as the far end of the measurement scales linearly with the frequency.

Depth sensing may be used to adapt to measurement range of the ToF sensor 120 to the distance of the object 101. Adapting the measurement range to the distance of the object may allow to increase the energy efficiency and/or consumption of the apparatus 100 as no active light, e.g., emitted modulated light 102, is unnecessarily wasted or drained. For example, the ToF sensor 120 may be further configured to perform one or more second ToF measurement prior to performing the above described ToF measurement for the reflectivity measurement. The processing circuitry 130 may be accordingly configured to determine a distance value indicating the distance to the object 101 based on an output of the ToF sensor 120 for the one or more second ToF measurement. The one or more second ToF measurement and the determination of the distance value may be performed according to conventional depth ToF depth sensing principles (e.g., using a respective oscillating correlation function). Further, the processing circuitry 130 may be configured to adjust, based on the distance value, the measurement range of the ToF sensor 120 for the above described ToF measurement to include the object 101. For example, the processing circuitry 130 may adjust the frequency and/or any other parameter of the one or more drive signal and the one or more illumination signal based on the determined distance value. Optionally, the processing circuitry 130 may output further data indicating the distance value. For example, one or more image indicating the reflectivity value and/or the distance value may be output may be output by the processing circuitry 130.

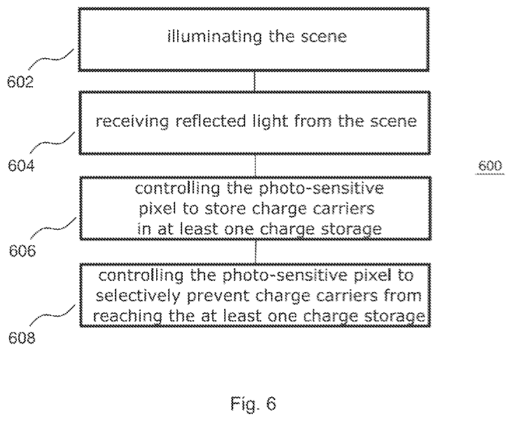

In order to summarize the proposed optical sensing, FIG. 6 illustrates a flowchart of an example of a method 600 for sensing a scene. The method 600 comprises illuminating 602 the scene with modulated light using an illumination element. Additionally, the method 600 comprises receiving 604 reflected light from the scene at an optical sensor. The optical sensor comprises at least one photo-sensitive sensor element or pixel. The method 600 further comprises controlling 606 the at least one photo-sensitive sensor element or pixel to store charge carriers generated in the photo-sensitive sensor element or pixel by the reflected light in at least one charge storage of the photo-sensitive sensor element or pixel during a measurement. In addition, the method 600 comprises controlling 608 the at least one photo-sensitive sensor element or pixel to selectively prevent the charge carriers from reaching the at least one charge storage during the measurement to strictly monotonically increase a sensitivity of the at least one photo-sensitive sensor element or pixel over distance for reflected light originating within a measurement range of the optical sensor.

The method 600 may allow to avoid saturation of the at least one photo-sensitive sensor element or pixel by reflected light coming from the close proximity of the optical sensor may be avoided. As a consequence, distortion of the measurement due to pixel saturation may be avoided.

More details and aspects of the method 600 are explained in connection with the proposed technique or one or more examples described above. The method 600 may comprise one or more additional optional features corresponding to one or more aspects of the proposed technique or one or more examples described above. In the following some example further features of the method 600 are described, however, it is to be noted that the method 600 is not limited thereto.

For example, the sensitivity may increase quadratically over distance within the measurement range as described above.

The method 600 may optionally further comprise determining a reflectivity value indicating a reflectivity of an object in the scene based on an output value of the at least one photo-sensitive sensor pixel for the measurement.

The optical sensor may, e.g., be a ToF sensor in the method 600. Accordingly, the measurement may be a ToF measurement.

In addition, the method 600 may further comprise performing one or more second ToF measurement using the ToF sensor prior to performing the ToF measurement. A distance value indicating a distance to the object may optionally be determined in method 600 based on an output of the ToF sensor for the one or more second ToF measurement. Further, the method 600 may comprise adjusting, based on the distance value, the measurement range of the ToF sensor for the ToF measurement to include the object.

Controlling 608 the at least one photo-sensitive sensor element or pixel to selectively prevent the charge carriers from reaching the at least one charge storage during the ToF measurement may, e.g., comprise controlling the at least one photo-sensitive sensor element or pixel to selectively drain the charge carriers.

### ASPECTS

The examples as described herein may be summarized as follows:

Aspects relate to an apparatus for sensing a scene. The apparatus includes an illumination element configured to illuminate the scene with modulated light. Additionally, the apparatus includes an optical sensor configured to receive reflected light from the scene. The optical sensor comprises at least one photo-sensitive sensor pixel configured to store charge carriers generated in the photo-sensitive sensor pixel by the reflected light in at least one charge storage of the photo-sensitive sensor pixel during a measurement. The at least one photo-sensitive sensor pixel is further configured to selectively prevent the charge carriers from reaching the at least one charge storage during the measurement to strictly monotonically increase a sensitivity of the at least one photo-sensitive sensor pixel over distance for reflected light originating within a measurement range of the optical sensor.

In some aspects, the sensitivity increases quadratically over distance within the measurement range.

According to some aspects, the photo-sensitive sensor pixel is further configured to increase a ratio of charge carriers stored in the at least one charge storage with increasing distance of the optical sensor to an object in the scene causing the reflected light.

In some aspects, the at least one photo-sensitive sensor pixel is further configured to selectively prevent the charge carriers from reaching the at least one charge storage based on at least one received drive signal.

According to some aspects, the apparatus further comprises processing circuitry configured to determine a reflectivity value indicating a reflectivity of an object in the scene based on an output value of the at least one photo-sensitive sensor pixel for the measurement.

According to some aspects, wherein the at least one photo-sensitive sensor pixel provides an integration state during which the charge carriers are being stored in the at least one charge storage, wherein the at least one photo-sensitive sensor pixel further provides a non-integrating state during which the charge carriers are prevented from reaching the at least one charge storage, wherein the at least one photo-sensitive sensor pixel is controlled to operate according to a state pattern during the measurement, the state pattern alternatingly comprising the integration state and the non-integrating state.

In some aspects, the optical sensor is a ToF sensor, wherein the measurement is a ToF measurement.

According to some aspects, a correlation function of the at least one photo-sensitive sensor pixel for the ToF measurement increases strictly monotonically over distance within the measurement range of the ToF sensor.

In some aspects, the correlation function gives the at least one photo-sensitive sensor pixel's distance-dependent correlation of the reflected light with one or more drive signal and without considering an intensity of the reflected light, the at least one photo-sensitive sensor pixel being driven based on the one or more drive signal.

According to some aspects, the correlation function increases quadratically over distance within the measurement range.

In some aspects, the at least one photo-sensitive sensor pixel is configured to: selectively store the charge carriers in at least two charge storages of the photo-sensitive sensor pixel during the ToF measurement; and selectively prevent the charge carriers from reaching the at least two charge storages during the ToF measurement.

According to some aspects, an output value of the at least one photo-sensitive sensor pixel for the ToF measurement is based on a charge difference between stored charges in the at least two charge storages.

According to some aspects, the at least one photo-sensitive sensor pixel provides an integration state during which the charge carriers are being stored in the at least two charge storages, wherein the at least one photo-sensitive sensor pixel further provides a non-integrating state during which the charge carriers are prevented from reaching the at least two charge storages, wherein the at least one photo-sensitive sensor pixel is controlled to operate according to a state pattern during the ToF measurement, the state pattern alternatingly comprising the integration state and the non-integrating state.

In some aspects, the ToF sensor is further configured to perform one or more second ToF measurement prior to performing the ToF measurement, and wherein the processing circuitry is configured to: determine a distance value indicating a distance to the object based on an output of the ToF sensor for the one or more second ToF measurement; and adjust, based on the distance value, the measurement range of the ToF sensor for the ToF measurement to include the object.

According to some aspects, the at least one photo-sensitive sensor pixel is configured to selectively prevent the charge carriers from reaching the at least one charge storage during the ToF measurement by selectively draining the charge carriers.

In alternative aspects, the optical sensor is an image sensor or a dynamic vision sensor.

Other aspects relate to a method for sensing a scene. The method comprises illuminating the scene with modulated light using an illumination element. Additionally, the method comprises receiving reflected light from the scene at an optical sensor. The optical sensor comprises at least one photo-sensitive sensor pixel. The method further comprises controlling the at least one photo-sensitive sensor pixel to store charge carriers generated in the photo-sensitive sensor pixel by the reflected light in at least one charge storage of the photo-sensitive sensor pixel during a measurement. In addition, the method comprises controlling the at least one photo-sensitive sensor pixel to selectively prevent the charge carriers from reaching the at least one charge storage during the measurement to strictly monotonically increase a sensitivity of the at least one photo-sensitive sensor pixel over distance for reflected light originating within a measurement range of the optical sensor.

In some aspects, the sensitivity increases quadratically over distance within the measurement range.

According to some aspects, the method further comprises determining a reflectivity value indicating a reflectivity of an object in the scene based on an output value of the at least one photo-sensitive sensor pixel for the measurement.

In some aspects, the optical sensor is a ToF sensor, and wherein the measurement is a ToF measurement.

According to some aspects, the method further comprises: performing one or more second ToF measurement using the ToF sensor prior to performing the ToF measurement; determining a distance value indicating a distance to the object based on an output of the ToF sensor for the one or more second ToF measurement; and adjusting, based on the distance value, the measurement range of the ToF sensor for the ToF measurement to include the object.

In some aspects, controlling the at least one photo-sensitive sensor pixel to selectively prevent the charge carriers from reaching the at least one charge storage during the ToF measurement comprises controlling the at least one photo-sensitive sensor pixel to selectively drain the charge carriers.

Aspects of the present disclosure may provide a camera system with active illumination (e.g., ToF) which increases its sensitivity over distance. For example, aspects of the present disclosure may allow to improve ToF sensor based face recognition in smartphones or object and material recognition for robotics and automation. Some aspects of the present disclosure may enable reflectance measurements using the drain gate feature of the sensor.

The aspects and features described in relation to a particular one of the previous aspects may also be combined with one or more of the further aspects to replace an identical or similar feature of that further aspect or to additionally introduce the features into the further aspect.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further aspects, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate aspect. It should also be noted that although in the claims a dependent claim refers to a particular combination with one or more other claims, other aspects may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for sensing a scene, comprising:
an illumination element configured to illuminate the scene with modulated light; and
an optical sensor configured to receive reflected light from the scene, wherein the optical sensor comprises a photo-sensitive sensor pixel configured to:
store charge carriers generated in the photo-sensitive sensor pixel by the reflected light in at least one charge storage of the photo-sensitive sensor pixel during a measurement, and
selectively prevent the charge carriers from reaching the at least one charge storage during the measurement to strictly monotonically increase a sensitivity of the photo-sensitive sensor pixel over distance for reflected light originating within a measurement range of the optical sensor-.

2. The apparatus of claim 1, wherein the sensitivity increases quadratically over distance within the measurement range.

3. The apparatus of claim 1, wherein the photo-sensitive sensor pixel is further configured to increase a ratio of charge carriers stored in the at least one charge storage with increasing distance of the optical sensor to an object in the scene causing the reflected light.

4. The apparatus of claim 1, wherein the photo-sensitive sensor pixel is further configured to selectively prevent the charge carriers from reaching the at least one charge storage based on at least one received drive signal.

5. The apparatus of claim 1, further comprising:
processing circuitry configured to determine a reflectivity value indicating a reflectivity of an object in the scene based on an output value of the photo-sensitive sensor pixel output for the measurement.

6. The apparatus of claim 1, wherein the optical sensor is a Time-of-Flight, (ToF) sensor, and wherein the measurement is a ToF measurement.

7. The apparatus of claim 6, wherein a correlation function of the photo-sensitive sensor pixel for the ToF measurement increases strictly monotonically over distance within the measurement range of the ToF sensor.

8. The apparatus of claim 7, wherein the correlation function provides a distance-dependent correlation of the reflected light with one or more drive signals and without considering an intensity of the reflected light, wherein the photo-sensitive sensor pixel is driven based on the one or more drive signals.

9. The apparatus of claim 7, wherein the correlation function increases quadratically over distance within the measurement range.

10. The apparatus of claim 6, wherein the photo-sensitive sensor pixel is configured to:
selectively store the charge carriers in at least two charge storages of the photo-sensitive sensor pixel during the ToF measurement; and
selectively prevent the charge carriers from reaching the at least two charge storages during the ToF measurement.

11. The apparatus of claim 10, wherein an output value of the photo-sensitive sensor pixel for the ToF measurement is based on a charge difference between stored charges in the at least two charge storages.

12. The apparatus of claim 6, further comprising:
processing circuitry configured to determine a reflectivity value indicating a reflectivity of an object in the scene based on an output value of the photo-sensitive sensor pixel output for the measurement,
wherein the ToF sensor is further configured to perform one or more second ToF measurements prior to performing the ToF measurement, and wherein the processing circuitry is configured to:
determine a distance value indicating a distance to the object based on an output of the ToF sensor for the one or more second ToF measurements, and
adjust, based on the distance value, the measurement range of the ToF sensor for the ToF measurement to include the object.

13. The apparatus of claim 6, wherein the photo-sensitive sensor pixel is configured to selectively prevent the charge carriers from reaching the at least one charge storage during the ToF measurement by selectively draining the charge carriers.

14. The apparatus of claim 1, wherein the optical sensor is an image sensor or a dynamic vision sensor.

15. A method for sensing a scene, the method comprising:
illuminating the scene with modulated light using an illumination element;
receiving reflected light from the scene at an optical sensor, wherein the optical sensor comprises a photo-sensitive sensor pixel;
controlling the photo-sensitive sensor pixel to:
store charge carriers generated in the photo-sensitive sensor pixel by the reflected light in at least one charge storage of the photo-sensitive sensor pixel during a measurement; and
selectively prevent the charge carriers from reaching the at least one charge storage during the measurement to strictly monotonically increase a sensitivity of the photo-sensitive sensor pixel over distance for reflected light originating within a measurement range of the optical sensor.

16. The method of claim 15, wherein the sensitivity increases quadratically over distance within the measurement range.

17. The method of claim 15, further comprising:
determining a reflectivity value indicating a reflectivity of an object in the scene based on an output value of the photo-sensitive sensor pixel output for the measurement.

18. The method of claim 15, wherein the optical sensor is a Time-of-Flight (ToF) sensor, and wherein the measurement is a ToF measurement.

19. The method of claim 18, further comprising:
performing one or more second ToF measurements using the ToF sensor prior to performing the ToF measurement;
determining a distance value indicating a distance to the object based on an output of the ToF sensor for the one or more second ToF measurements; and
adjusting, based on the distance value, the measurement range of the ToF sensor for the ToF measurement to include the object.

20. The method of claim 18, wherein controlling the photo-sensitive sensor pixel to selectively prevent the charge carriers from reaching the at least one charge storage during the ToF measurement comprises controlling the photo-sensitive sensor pixel to selectively drain the charge carriers.
